(19) United States
(12) Patent Application Publication
(10) Pub. No.: US 2002/0110143 A1
(43) Pub. Date: Aug. 15, 2002

(54) Transmission system with detection of ability to handle unsolicited grants

(76) Inventor: Ewa Barbara Hekstra-Nowacka, Eindhoven (NL)

Correspondence Address: U.S. Philips Corporation, 580 White Plains Road, Tarrytown, NY, 10591, US

(21) Appl. No.: 10/058,450

(22) Filed: Jan. 28, 2002

(30) Foreign Application Priority Data
Jan. 31, 2001 (EP) 01200352.1

(51) Int. Cl. H04L 12/413

(52) U.S. Cl. 370/447; 725/116

(57) ABSTRACT

Described is a transmission system comprising at least one primary station (2) and at least one secondary station (4). The primary station (2) and the secondary station (4) are coupled to each other via a transmission medium (14). The secondary station (4) comprises data transmission request means (36, 42, 44) for transmitting a data transmission request (70) to the primary station (2) when transmission data are available in the secondary station (4). The transmission system is characterized in that the primary station (2) comprises transmission means (20, 22, 26) for transmitting, upon receipt of the data transmission request (70), a data transmission refusal (72) followed by a data transmission grant (74) to the secondary station (4). The primary station (2) comprises monitoring means (22, 28) for monitoring the transmission of data (76) by the secondary station (2) in response to the data transmission grant (74). In this way, the primary station (2) can determine the ability of the secondary station (4) to handle unsolicited grants.

The invention relates to a transmission system comprising at least one primary station being coupled via a transmission medium to at least one secondary station, the secondary station comprising data transmission request means for transmitting a data transmission request to the primary station when transmission data are available in the secondary station.

The invention further relates to a primary station comprising receiving means for receiving a data transmission request from a secondary station and to a method of determining whether a secondary station can process unsolicited data transmission grants.

A transmission system according to the preamble is known from the ETSI (European Telecommunications Standards Institute) Standard EN 300 800 (May 28, 1999) entitled “Digital Video Broadcasting (DVB); DVB interaction channel for Cable TV distribution systems (CATV)”.

Such transmission systems are used for the communication between one or more secondary stations to one or more primary stations, via a transmission medium which may be (partially) common to some of the secondary stations. Such transmission medium can comprise an optical fibre, a coaxial cable, or a radio link. Application of such transmission systems can be passive optical networks, cable TV systems, local area networks, multimedia networks, systems for satellite communication and mobile radio systems.

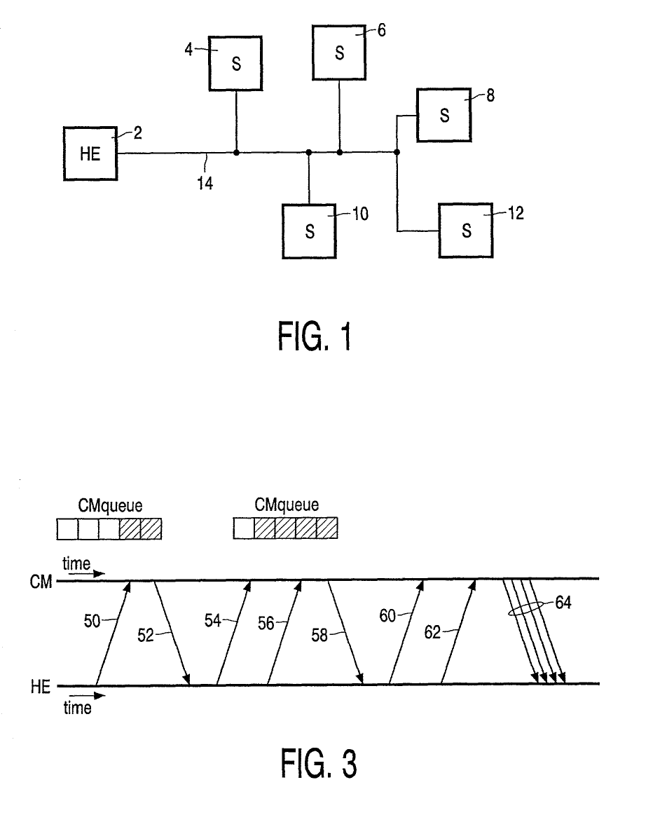

FIG. 1 shows a block diagram of the known transmission system, which transmission system is a DVB-compliant cable television or community antenna television (CATV) transmission system. The known transmission system comprises an Interactive Network Adapter (INA) or cable modem termination system (CMTS) as (part of) a primary station 2 and Network Interface Units (NIU) or cable modems (CM) as (part of) secondary stations 4, 6, 8, 10, 12. A CMTS broadcasts data downstream to the cable modems and controls the access of the cable modems to the upstream channel (i.e. from the cable modems to the CMTS). Cable modems are devices that allow high-speed data access to e.g. the Internet via a cable television (CATV) network. While similar in some respects to a traditional analogue modem, a cable modem is significantly more powerful, capable of delivering data approximately 500 times faster. Current Internet access via a 28.8-, 33.6-, or 56-kbps modem is referred to as voiceband modem technology. Like voiceband modems, cable modems modulate and demodulate data signals. However, cable modems incorporate more functionality suitable for today's high-speed Internet services.

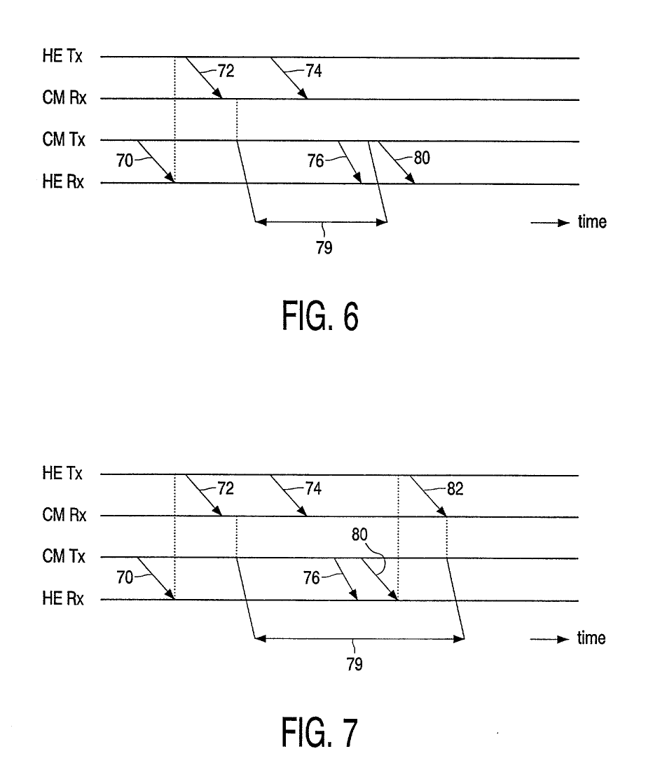

The primary station 2 and the secondary stations 4 . . . 12 are coupled by a transmission medium 14. This transmission medium 14, which may comprise a so-called hybrid fibre-coax network or BFC network, is (partly) in common for a plurality of the secondary stations 4 . . . 12. Communications from the primary station 2 to the secondary stations 4 . . . 12 are conducted over downstream channels and communications from the secondary stations 4 . . . 12 to the primary station 2 are conducted over upstream channels. The primary station 2 controls the access to the (shared) transmission medium 14 by the secondary stations 4 . . . 12. When one of the secondary stations 4 . . . 12 wants to transmit data to the primary station 2, it first has to transmit a data transmission request 70 (see FIGS. 6 and 7) to the primary station 2.

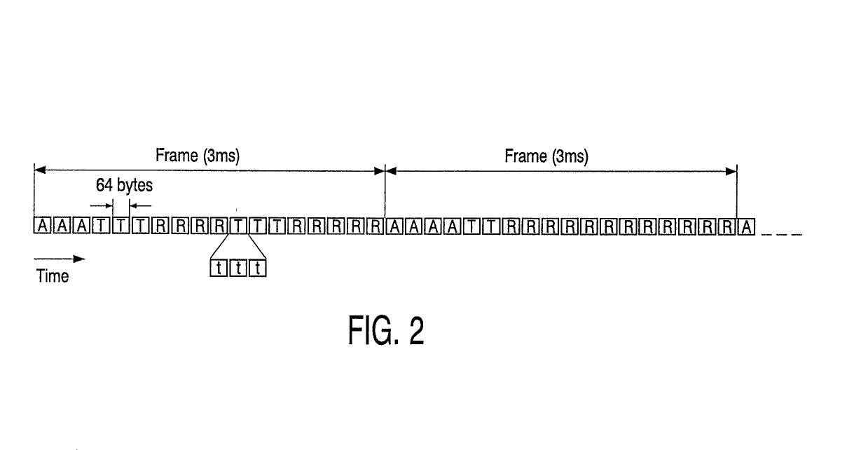

Upstream communications (i.e. from the secondary stations 4 . . . 12 to the primary station 2) are conducted by means of upstream frames of typically three milliseconds duration (in case of an upstream bitrate of 3.088 Mb/s). In FIG. 2 a possible sequence of two upstream frames is shown. These upstream frames comprise eighteen slots of sixty-four bytes (again, in case of an upstream bitrate of 3.088 Mb/s). Each upstream frame comprises a number of Aloha slots A, a number of Tree slots T and a number of Reservation slots R. Each Tree slot T comprises three Tree minislots t. The structure of each upstream frame (i.e. the number and position of the Aloha, Tree and Reservation slots) is dynamically defined by the primary station 2. By means of the Reservations slots R the secondary stations 4 . . . 12 can have collision-free access (i.e. without interference from other secondary stations) to the transmission medium 14. In contrast, by means of the Aloha slots A or the Tree slots T the secondary stations 4 . . . 12 can have contention-based access to the transmission medium 14, i.e. two or more secondary stations 4 . . . 12 may be accessing (the same channels/slots of) the transmission medium 14 at the same time resulting in erroneous communications.

The transmission of application data by a secondary station 4 to the primary station 2 is generally organized by a request-grant mechanism as illustrated in FIG. 3. In this FIG. 3 two lines are shown: a first line labelled HE (or primary station 2) and a second line labelled CM (or secondary station 4). Communications from the primary station 2 to the secondary station 4 are indicated by means of arrows from the HE-line to the CM-line. Communications from the secondary station 4 to the primary station 2 are indicated by means of arrows from the CM-line to the HE-line. At dedicated moments (i.e. after the secondary station 4 has received a contention grant 50 from the primary station 2), the secondary station 4 transmits a data transmission request 52 to the primary station 2 requesting (contentionless) upstream transmission time for the transmission of two units of application data (which units are schematically indicated by means of the two grey cells in the leftmost data buffer CMqueue of the secondary station 4). The contention grant 50 may be an Aloha or a Tree grant. The data transmission request 52 is transmitted by the secondary station 4 in contention slots (as specified in the contention grant 50).

The primary station 2 provides the secondary station 4 with feedback information indicating the success or failure of the transmission of the data transmission request 52. By means of feedback information 54 the secondary station 4 is informed that the transmission of the data transmission request 52 collided with another data transmission request from another secondary station. Hereafter, the secondary station 4 has to transmit a second data transmission request 58 (after having received a second contention grant 56). At the moment of transmitting this second data transmission request 58 the data buffer CMqueue is filled with four units of data (as indicated in the rightmost data buffer CMqueue) and accordingly the second data transmission request 58 is a request for the transmission of four units of data.

The secondary station 4 then awaits one or more reservation grants from the primary station 2, which reservation grants indicate when to transmit the application data. In FIG. 3 the primary station 2 transmits a reservation grant 62 to the secondary station 4, indicating that the secondary station 4 may transmit four units of data. Finally, the secondary station 4 can transmit the four units of application data 64 at the indicated time(s), i.e. in the reservation slots indicated by the reservation grant 62.

Data transmission requests, which are often called reservation requests, are typically sent in contention access, governed by the Aloha or Tree protocol. The primary station 2 sends explicit feedback (success or failure) on the content of upstream contention (mini-)slots to the secondary stations 4 . . . 12. If this feedback indicates that the transmission of a reservation request failed (i.e. collided with another reservation request) the secondary station may transmit a new reservation request. For the Aloha protocol, the primary station 2 utilizes the reception indicator fields (which are included in the MAC flags, see sections 5.3.1.3 and 5.5.2.4 of the above mentioned DVB-standard) to inform the secondary stations 4 . . . 12 whether successful reception of the content of upstream slots has been obtained. For the Tree protocol, the explicit feedback on the content of upstream contention minislots is sent in a so-called reservation grant message (RGM, see table 40 of the above mentioned DVB-standard).

For the implementation of certain types of services, for instance voice (e.g. Voice over IP) or fax services, it is necessary that the primary station can guarantee a minimum upstream data rate or a constant upstream data rate in order to minimize undesired jitter and delays. A known method of guaranteeing such a minimum or constant data rate is by using a so-called fixed rate service. However, in case of a minimum data rate service, the use of such a fixed rate service is not very efficient as valuable upstream bandwidth is spoiled when no or little data are transmitted by the secondary stations. A more bandwidth efficient method of guaranteeing a minimum upstream data rate makes use of so-called unsolicited grants. All cable modems complying with the so-called DOCSIS standard (as described in the document “Data-Over-Cable Service Interface Specifications, Radio Frequency Interface Specification, SP-RFIv1.1-W01-981008”) must be able to handle these unsolicited grants. Therefore, in a DOCSIS-compliant transmission system the primary station (CMTS) knows that all secondary stations (CM) can handle unsolicited grants and can supply a certain minimum upstream data rate. In contrast, in the above mentioned DVB-standard the concept of unsolicited grants is not mentioned at all. It is not mandatory that the secondary stations which comply with this standard can handle unsolicited grants. Hence, some of the secondary stations may be able to handle unsolicited grants, while others (e.g. from a different vendor) may not.

It is an object of the invention to provide a transmission system as described in the opening paragraph in which the primary station can determine whether a secondary station can handle unsolicited grants. This object is achieved in the transmission system according to the invention, which transmission system is characterised in that the primary station comprises transmission means for transmitting, upon receipt of the data transmission request, a data transmission refusal followed by a data transmission grant to the secondary station, the primary station comprising monitoring means for monitoring the transmission of data by the secondary station in response to the data transmission grant. By receipt of the data transmission request the primary station is informed of the fact that the secondary station has data available for transmission. By transmitting a data transmission refusal in response to the data transmission request the secondary station is informed by the primary station that the secondary station is not given permission to transmit its data. Thereafter the primary station transmits a data transmission grant to the secondary station, indicating that the secondary station may transmit (part of) its data. This data transmission grant is an unsolicited grant as it is not connected to the data transmission request (which data transmission request was terminated by the data transmission refusal). If the secondary station is able to handle this unsolicited grant it will transmit data in response to the data transmission grant. If the secondary station is not able to handle this unsolicited grant it will not do so. The primary station can determine whether the secondary station is able to handle unsolicited grants by monitoring whether the secondary station transmits data in response to the unsolicited data transmission grant.

An embodiment of the transmission system according to the invention is characterised in that the transmission system comprises a CATV system, wherein the primary station comprises a cable modem termination system and wherein the secondary station comprises a cable modem. The invention may be advantageously applied in CATV systems with cable modems and (a) cable modem termination system(s).

An embodiment of the transmission system according to the invention is characterised in that the CATV system and the cable modem termination system and the cable modem are DVB-compliant. In the above mentioned DVB-standard a CATV system with cable modems and a cable termination system is described, but the concept of unsolicited grants is not mentioned at all. Therefore, such DVB-compliant cable modems may or may not support unsolicited grants. In such a DVB-compliant CATV system the invention may be applied advantageously so that the cable modem termination system can determine whether the cable modem supports unsolicited grants.

A further embodiment of the transmission system according to the invention is characterised in that the data transmission refusal comprises a reservation grant message with a remaining slot_count and a grant_slot_count, wherein the remaining slot_count is equal to zero and wherein the grant slot_count is equal to zero. The structure of the reservation grant message is shown in table 40 of the above mentioned DVB-document. By setting the remaining_slot_count and the grant slot_count to zero the primary station can effectively prevent the secondary station from transmitting data in response to the data transmission request.

Another embodiment of the transmission system according to the invention is characterised in that the data transmission grant comprises a further reservation grant message with a further remaining slot_count and a further grant_slot_count, wherein the further remaining_slot_count is equal to zero and wherein the further grant_slot_count is equal to or larger than one. By setting the further remaining_{—‘slot}_count to zero and the further grant_slot_count to a value n larger than zero a (unsolicited) grant for the transmission of n data units is achieved.

Another embodiment of the transmission system according to the invention is characterised in that the CATV system and the cable modem termination system and the cable modem are IEEE 802.14-compliant. In the IEEE 802.14 standard a CATV system with cable modems and a cable termination system is described, but the concept of unsolicited grants is not mentioned at all. Therefore, such IEEE 802.14-compliant cable modems may or may not support unsolicited grants. In such a EEEE 802.14-compliant CATV system the invention may be applied advantageously so that the cable modem termination system can determine whether the cable modem support unsolicited grants.

Another embodiment of the transmission system according to the invention is characterised in that the transmission system comprises a satellite communication system, wherein the primary station comprises a ground station and wherein the secondary station comprises a satellite receiver. The invention may be applied advantageously in satellite communication systems such as the DVB-S satellite communication systems. In order to guarantee a certain (minimum or constant bitrate) service to a satellite receiver it might be necessary for the ground station to know whether that satellite receiver can handle unsolicited grants. The ground station can determine this by applying the novel and inventive concept as described above.

The above object and features of the present invention will be more apparent from the following description of the preferred embodiments with reference to the drawings, wherein:

FIG. 1 shows a block diagram of an embodiment of the transmission system according to the invention,

FIG. 2 shows a sequence of two upstream frames,

FIG. 3 shows a diagram illustrating the request grant mechanism,

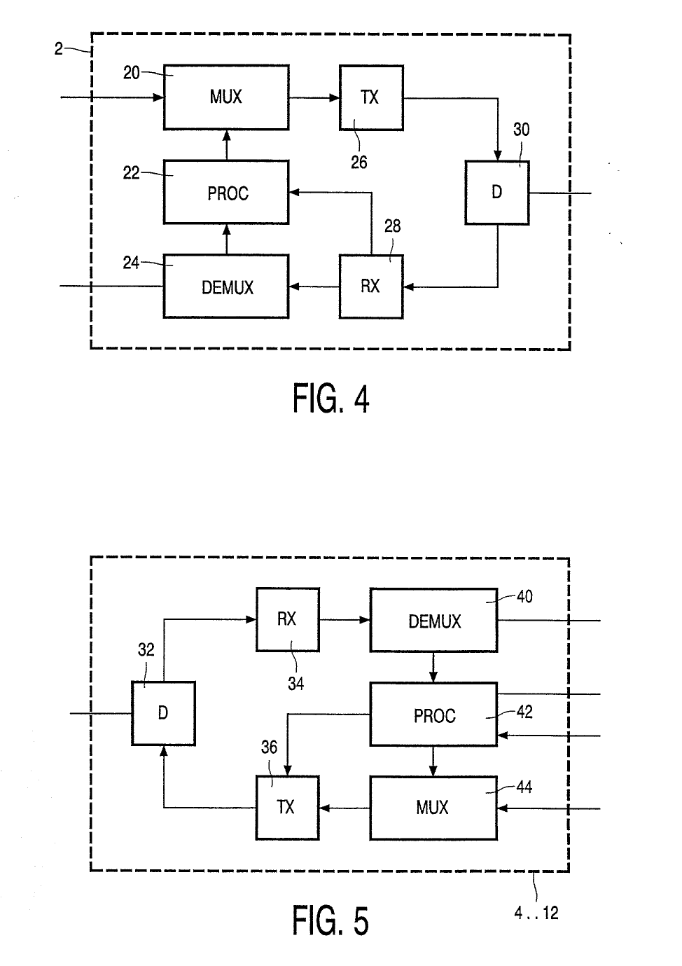

FIG. 4 shows a block diagram of an embodiment of a primary station according to the invention,

FIG. 5 shows a block diagram of an embodiment of a secondary station according to the invention,

FIGS. 6 and 7 show diagrams illustrating the operation of the transmission system according to the invention.

In the Figs. , identical parts are provided with the same reference numbers.

FIG. 1 shows a block diagram of an embodiment of the transmission system according to the invention, which transmission system is a DVB-compliant cable television or community antenna television (CATV) transmission system. The transmission system comprises an Interactive Network Adapter (INA) or cable modem termination system (CMTS) as (part of) a primary station 2 and Network Interface Units (NIU) or cable modems (CM) as (part of) secondary stations 4, 6, 8, 10, 12. A CMTS broadcasts data downstream to the cable modems and controls the access of the cable modems to the upstream channel (i.e. from the cable modems to the CMTS).

The primary station 2 and the secondary stations 4 . . . 12 are coupled by a transmission medium 14. This transmission medium 14, which may comprise a so-called hybrid fibre-coax network or HFC network, is (partly) in common for a plurality of the secondary stations 4 . . . 12. Communications from the primary station 2 to the secondary stations 4 . . . 12 are conducted over downstream channels and communications from the secondary stations 4 . . . 12 to the primary station 2 are conducted over upstream channels. The primary station 2 controls the access to the (shared) transmission medium 14 by the secondary stations 4 . . . 12. When one of the secondary stations 4 . . . 12 wants to transmit data to the primary station 2, it first has to transmit a data transmission request 70 (see FIGS. 6 and 7) to the primary station 2.

Upstream communications (i.e. from the secondary stations 4 . . . 12 to the primary station 2) are conducted by means of upstream frames of typically three milliseconds duration (in case of an upstream bitrate of 3.088 Mb/s). In FIG. 2 a possible sequence of two upstream frames is shown. These upstream frames comprise eighteen slots of sixty-four bytes (again, in case of an upstream bitrate of 3.088 Mb/s). Each upstream frame comprises a number of Aloha slots A, a number of Tree slots T and a number of Reservation slots R. Each Tree slot T comprises three Tree minislots t. The structure of each upstream frame (i.e. the number and position of the Aloha, Tree and Reservation slots) is dynamically defined by the primary station 2. By means of the Reservations slots R the secondary stations 4 . . . 12 can have collision-free access (i.e. without interference from other secondary stations) to the transmission medium 14. In contrast, by means of the Aloha slots A or the Tree slots T the secondary stations 4 . . . 12 can have contention-based access to the transmission medium 14, i.e. two or more secondary stations 4 . . . 12 may be accessing (the same channels/slots of) the transmission medium 14 at the same time resulting in erroneous communications.

The transmission of application data by a secondary station 4 to the primary station 2 is generally organized by a request-grant mechanism as illustrated in FIG. 3. In this FIG. 3 two lines are shown: a first line labelled HE (or primary station 2) and a second line labelled CM (or secondary station 4). Communications from the primary station 2 to the secondary station 4 are indicated by means of arrows from the HE-line to the CM-line. Communications from the secondary station 4 to the primary station 2 are indicated by means of arrows from the CM-line to the HE-line. At dedicated moments (i.e. after the secondary station 4 has received a contention grant 50 from the primary station 2), the secondary station 4 transmits a data transmission request 52 to the primary station 2 requesting (contentionless) upstream transmission time for the transmission of two units of application data (which units are schematically indicated by means of the two grey cells in the leftmost data buffer CMqueue of the secondary station 4). The contention grant 50 may be an Aloha or a Tree grant. The data transmission request 52 is transmitted by the secondary station 4 in contention slots (as specified in the contention grant 50).

The primary station 2 provides the secondary station 4 with feedback information indicating the success or failure of the transmission of the data transmission request 52. By means of feedback information 54 the secondary station 4 is informed that the transmission of the data transmission request 52 collided with another data transmission request from another secondary station. Hereafter, the secondary station 4 has to transmit a second data transmission request 58 (after having received a second contention grant 56). At the moment of transmitting this second data transmission request 58 the data buffer CMqueue is filled with four units of data (as indicated in the rightmost data buffer CMqueue) and accordingly the second data transmission request 58 is a request for the transmission of four units of data.

The secondary station 4 then awaits one or more reservation grants from the primary station 2, which reservation grants indicate when to transmit the application data. In FIG. 3 the primary station 2 transmits a reservation grant 62 to the secondary station 4, indicating that the secondary station 4 may transmit four units of data. Finally, the secondary station 4 can transmit the four units of application data 64 at the indicated time(s) , i.e. in the reservation slots indicated by the reservation grant 62.

Data transmission requests, which are often called reservation requests, are typically sent in contention access, governed by the Aloha or Tree protocol. The primary station 2 sends explicit feedback (success or failure) on the content of upstream contention (mini-)slots to the secondary stations 4 . . . 12. If this feedback indicates that the transmission of a reservation request failed (i.e. collided with another reservation request) the secondary station may transmit a new reservation request. For the Aloha protocol, the primary station 2 utilizes the reception indicator fields (which are included in the MAC flags, see sections 5.3.1.3 and 5.5.2.4 of the above mentioned DVB-standard) to inform the secondary stations 4 . . . 12 whether successful reception of the content of upstream slots has been obtained. For the Tree protocol, the explicit feedback on the content of upstream contention minislots is sent in a so-called reservation grant message (RGM, see table 40 of the above mentioned DVB-standard).

If the reservation requests are governed by the Aloha protocol, the Maximum_Contention_Access_Message_Length field of the Connect Message (see section 5.5.5.1 of the above mentioned DVB-standard) must be set to zero in order to prevent the transmission of data in Aloha slots. If the secondary station can transmit data in Aloha slots it is not guaranteed that the secondary station will have data to transmit in response to the data transmission grant and in such a situation the primary station can incorrectly come to the conclusion that the secondary station cannot handle/support unsolicited grants.

In the primary station 2 according to FIG. 4, a downstream signal is applied to a first input of a multiplexer 20. An output of a processor 22 is connected to a second input of the multiplexer 20. The output of the multiplexer 20 is connected to an input of a transmitter 26. The output of the transmitter 26 is connected to an input of a duplexer 30. An input/output of the duplexer 30 is connected to the transmission medium 14.

An output of the duplexer 30 is connected to an input of a receiver 28. The output of the receiver 28 is connected to an input of a demultiplexer 24. A first output of the demultiplexer 24 is connected to the processor 22. A second output of the demultiplexer 24 carries a signal to be handled by a higher protocol layer.

The transmission means for transmitting a data transmission refusal followed by a data transmission grant are constituted by the combination of the processor 22, the multiplexer 20 and the transmitter 26. The monitoring means for monitoring the transmission of data by the secondary station in response to the data transmission grant are constituted by the combination of the receiver 28 and the processor 22. The receiving means for receiving a data transmission request from a secondary station are constituted by the combination of the receiver 28, the demultiplexer 24 and the processor 22.

Payload signals and control signals are multiplexed in a downstream frame by the multiplexer 20. The control signals are provided by the processor 22. The output signal of the multiplexer is modulated on one or more carriers by the transmitter 26 and subsequently applied to the transmission medium via the duplexer 30.

The duplexer 30 applies its output signal to the input of the receiver 28. The receiver is arranged for demodulating one or more carriers, because a plurality of carriers can be used for different groups of secondary stations. The output signal(s) of the receiver 28 is/are demultiplexed by the demultiplexer 24. The control information, such as data transmission requests, that is available at the first output of the demultiplexer 24 is applied to the processor 22.

A data transmission request from a secondary station is received by the processor 22 via the receiver 28 and the demultiplexer 24. Upon receipt of the data transmission request the processor 22 can transmit a data transmission refusal followed by a data transmission grant to the secondary station via the multiplexer 20 and the transmitter 26. When the secondary station, in response to the data transmission grant, transmits data, this data is received by the processor 22 via the receiver 28. The processor 22 can then determine that these data were transmitted by the secondary station in response to the data transmission grant and it is established that the secondary station can handle/support unsolicited grants.

In the secondary station 4 . . . 12 according to FIG. 5, a signal to be transmitted upstream is applied to a first input of a multiplexer 44. The output of the multiplexer 44 is connected to an input of a transmitter 36. The output of the transmitter 36 is connected to an input of a duplexer 32, whose input/output is connected to the transmission medium 14. A first subscriber control signal is applied to a processor 42. A first output of the processor 42 is connected to a second input of the multiplexer 44. A second output of the processor 42 is connected to the transmitter 36, and a third output of the processor 42 carries a second subscriber control signal.

An output of the duplexer 32 is connected to an input of a receiver 34. The output of the receiver 34 is connected to an input of a demultiplexer 40. A first output of the demultiplexer 40 is connected to a second input of the processor 42. A second output of the demultiplexer 40 carries the payload data.

The data transmission request means comprise the processor 42, the multiplexer 44 and the transmitter 36.

The downstream signal transmitted by the primary station 2, is passed to the receiver 34 by the duplexer 32. Said downstream signal is demodulated in the receiver 34, and the resulting digital symbols are passed to the demultiplexer 40. The demultiplexer 40 separates the control data and the payload data present in the output signal of the receiver. The control data is transmitted to the processor and the payload data is made available for a subscriber terminal.

If the subscriber terminal has data to be transmitted to the primary station 2, this is signaled to the processor 42 using the first subscriber control signal. In response to said signal the processor will submit a data transmission request. This is done by switching on the transmitter 36. Via the multiplexer 44 the data transmission request is passed to the input of the transmitter 36. At the output of the transmitter 36 the data transmission request is available and is passed via the transmission medium 14 to the primary station 2.

If the primary station 2 allocates transmission capacity to the secondary station, the processor 42 signals to the subscriber terminal that it can transmit data. This data is multiplexed with control information, and is transmitted to the primary station 2.

FIGS. 6 and 7 show diagrams illustrating the operation of the transmission system according to the invention. In these FIGS. 6 and 7, a line labelled HE Tx denotes a transmitting primary station and a line labelled HE Rx denotes a receiving primary station. Similarly, a line labelled CM Tx denotes a transmitting secondary station and a line labelled CM Rx denotes a receiving secondary station. Communications from the primary station 2 to the secondary station 4 are indicated by arrows from the HE Tx line to the CM Rx line. Communications from the secondary station 4 to the primary station 4 are indicated by arrows from the CM Tx line to the HE Rx line.

To guarantee the usage of unsolicited grants by a secondary station that is capable of accepting/handling them that secondary station should have transmission data in its buffer. A secondary station that has transmission data in its buffer is transmitting reservation requests. The proposed method of determining whether a secondary station can process unsolicited data transmission grants can be applied at any time during the activity of a secondary station. However, for clarity of explanation only the beginning of an activity period is described here.

A first reservation request 70 is transmitted from the secondary station 4 to the primary station 2. This makes the primary station 2 aware that there is application data in the connection buffer of the secondary station 4. After the feedback on this request has been issued (not shown), the test procedure proceeds as follows: in reply to the reservation request 70, the primary station transmits a data transmission refusal 72 to the secondary station 4. This data transmission refusal 72 comprises a reservation grant message with a Remaining_slot_count of zero and a grant_slot_count of zero. With such a message content, the primary station 2 lets the secondary station 4 know that it has seen the reservation request but that it is not going to grant this request at all. Therefore, when the secondary station 4 has received the data transmission refusal 72 it will wait until the first transmission opportunity in the contention process to transmit another reservation request 80 (for data which are present in the buffer of the secondary station 4). In the meantime, the primary station 2 transmits a data transmission grant 74 to the secondary station 4. This data transmission grant 74 comprises a further reservation grant message with a further remaining_slot_count of zero and a further_grant_slot_count of one or more than one. The further remaining slot count is set to zero to enable the secondary station 4 to make requests for proper amounts of upstream transmission slots, i.e. according to actual connection needs. By applying a non-zero value of the further grant_slot_count a single (or more) unsolicited grants are issued. This data transmission grant 74 is an unsolicited grant as it is not connected to a reservation request. The usage of this unsolicited grant 74 can be monitored by the primary station 2 and provides necessary information about the ability of the secondary station 4 to handle/support unsolicited grants. When the secondary station 4 transmits data 76 in response to the data transmission grant 74 it is clear that the secondary station 4 can handle/support unsolicited grants. When the secondary station 4 does not transmit data 76 in response to the data transmission grant 74 it is clear that the secondary station 4 cannot handle/support unsolicited grants.

However, it must be ensured that the secondary station 4 does not consider the unsolicited grant 74 as a reaction on its request 80 and that the secondary station 4 does not use the granted slot for the transmission of a reservation request (i.e. cycle stealing). This is achieved by letting the secondary station 4 transmit the data 76 before the next available contention transmission opportunity in which the reservation request 80 can be sent. As the primary station 2 controls grant assignments as well as issuing feedback this condition can be guaranteed. The time window in which the data 76 should be transmitted by the secondary station 4 is indicated in FIG. 6 by arrow 79.

From the above mentioned DVB-standard it is not clear/conclusive whether the feedback on contention (mini-)slots in which a successful request has been transmitted must precede the reservation grants associated with this request. However, if this is the case, the transmission opportunity related to the unsolicited grant should appear before the secondary station 4 receives feedback 82 on its second request 80, as illustrated in FIG. 7. This relaxes the time constraint on the time window 79.

The scope of the invention is not limited to the embodiments explicitly disclosed. The invention is embodied in each new characteristic and each combination of characteristics. In particular, the invention may be applied in any transmission system using a request grant mechanism and in which it is not clear which secondary stations (if any) can handle unsolicited grants. Any reference signs do not limit the scope of the claims. The word “comprising” does not exclude the presence of other elements or steps than those listed in a claim. Use of the word “a” or “an” preceding an element does not exclude the presence of a plurality of such elements.

1. A transmission system comprising at least one primary station (2) being coupled via a transmission medium (14) to at least one secondary station (4), the secondary station (4) comprising data transmission request means (36, 42, 44) for transmitting a data transmission request (70) to the primary station (2) when transmission data are available in the secondary station (4), characterised in that the primary station (2) comprises transmission means (20, 22, 26) for transmitting, upon receipt of the data transmission request (70), a data transmission refusal (72) followed by a data transmission grant (74) to the secondary station (4), the primary station (2) comprising monitoring means (22, 28) for monitoring the transmission of data (76) by the secondary station (2) in response to the data transmission grant (74).

2. The transmission system according to claim 1, characterised in that the transmission system comprises a CATV system, wherein the primary station (2) comprises a cable modem termination system and wherein the secondary station (4) comprises a cable modem.

3. The transmission system according to claim 2, characterised in that the CATV system and the cable modem termination system and the cable modem are DVB-compliant.

4. The transmission system according to claim 3, characterised in that the data transmission refusal (72) comprises a reservation grant message with a remaining slot_count and a grant_slot_count, wherein the remaining_slot_count is equal to zero and wherein the grant_slot_count is equal to zero.

5. The transmission system according to claim 4, characterised in that the data transmission grant (74) comprises a further reservation grant message with a further remaining_slot_count and a further grant_slot_count, wherein the further remaining_slot_count is equal to zero and wherein the further grant_slot_count is equal to or larger than one.

6. The transmission system according to claim 2, characterised in that the CATV system and the cable modem termination system and the cable modem are IEEE 802.14-compliant.

7. The transmission system according to claim 1, characterised in that the transmission system comprises a satellite communication system, wherein the primary station comprises a ground station and wherein the secondary station comprises a satellite receiver.

8. The transmission system according to claim 7, characterised in that the satellite communication system is DVB-compliant.

9. A primary station (2) comprising receiving means (22, 24, 28) for receiving a data transmission request (70) from a secondary station (4), characterised in that the primary station (2) comprises transmission means (20, 22, 26) for transmitting, upon receipt of the data transmission request (70), a data transmission refusal (72) followed by a data transmission grant (74) to the secondary station (4), the primary station (2) comprising monitoring means (22, 28) for monitoring the transmission of data (76) by the secondary station (4) in response to the data transmission grant (74).

10. The primary station (2) according to claim 9, characterised in that the primary station (2) comprises a cable modem termination system.

11. The primary station (2) according to claim 10, characterised in that the cable modem termination system is DVB-compliant.

12. The primary station (2) according to claim 11, characterised in that the data transmission refusal (72) comprises a reservation grant message with a remaining_slot_count and a grant_slot_count, wherein the remaining slot count is equal to zero and wherein the grant_slot_count is equal to zero.

13. The primary station (2) according to claim 12, characterised in that the data transmission grant (74) comprises a further reservation grant message with a further remaining_slot_count and a further grant_slot_count, wherein the further remaining_slot_count is equal to zero and wherein the further grant_slot_count is equal to or larger than one.

14. A method of determining whether a secondary station (4) can process unsolicited data transmission grants (74), the method comprising receiving a data transmission request (70) from the secondary station (4) when transmission data are available in the secondary station (4), characterised in that the method further comprises:
transmitting, upon receipt of the data transmission request (70), a data transmission refusal (72) followed by a data transmission grant (74) to the secondary station (4),
monitoring the transmission of data (76) by the secondary station (4) in response to the data transmission grant (74).

15. The method according to claim 14, characterised in that the secondary station (4) comprises a cable modem.

16. The method according to claim 15, characterised in that the cable modem is DVB-compliant.

17. The method according to claim 16, characterised in that the data transmission refusal (72) comprises a reservation grant message with a remaining_slot_count and a grant_slot_count, wherein the remaining slot count is equal to zero and wherein the grant_slot_count is equal to zero.

18. The method according to claim 17, characterised in that the data transmission grant (74) comprises a further reservation grant message with a further remaining slot count and a further grant_slot_count, wherein the further remaining_slot_count is equal to zero and wherein the further grant_slot_count is equal to or larger than one.
